(19) United States
(12) Patent Application Publication
(10) Pub. No.: US 2004/0184524 A1
(43) Pub. Date: Sep. 23, 2004

(54) Method for compressing and displaying still image data and moving image data

(76) Inventors: Hiroshi Akimoto, Kawasaki-shi (JP); Katuski Dosho, Kawasaki-shi (JP)

Correspondence Address: Garrison & Associates PS, Suite 3300, 2001 Sixth Avenue, Seattle, WA, 98121-2522, US

(21) Appl. No.: 10/647,973

(22) Filed: Aug. 26, 2003

(30) Foreign Application Priority Data
Aug. 27, 2002 (JP) 2002-246459

(51) Int. Cl. H04N 7/12

(52) U.S. Cl. 375/240.01; 375/240; 375/240.13

(57) ABSTRACT

Still image data or moving image data is compressed and transmitted in a low number of frames or pixels, or in a low number of frames and pixels. After the data is transmitted, it is decompressed in a low number of frames or pixels, or in a low number of frames and pixels. The data is then displayed in a high number of frames or pixels or, frames and pixels after time image interpolation, spatial image interpolation, or both time and spatial image interpolation. In another embodiment, image data is compressed as above and then stored in memory in a low number of frames and/or pixels. After storage, the data is retrieved in a low number of frames or pixels, or frames and pixels, and displayed after converting it in a high number of frames and/or pixels using image interpolation as noted above.

### CROSS REFERENCE TO RELATED APPLICATION

This application claims priority from Japanese Application No. 2002-246459 entitled, Advanced Compression Method of Still Image Data and Moving Image Data, filed on Aug. 27, 2002.

### TECHNICAL FIELD

The current invention relates to a method for compressing still image data and moving image data. More specifically, the invention discloses a method for facilitating transmission and storage in low memory of high-quality image at low bit rates.

### BACKGROUND OF THE INVENTION

Numerous compression technologies have been used in transmission and storing of still image and moving image data. The existing typical compression technologies used for still images and moving images include MPEG1, MPEG2, MPEG4, JPEG and JPEG2000.

JPEG is applied to compress the information volume of still images. MPEG1 is a standard developed for moving image by experts of various organizations under promotion by ISO. MPEG2 has been developed for a wide range of applications including broadcasting, communication and recording. It is a basic encoding system for digitalization of broadcasting such as multi-channel digital broadcasting. Currently when using these compression technologies, data can be compressed, transmitted, received, stored or saved with the specified bit rates.

A vast amount of data such as still image and moving image, however, can not be transmitted or received with satisfactory quality of image. At low bit rates, in particular, the moving image cannot be transmitted or received at a satisfactory quality of image according to the conventional technologies. In addition, storage of images requires a large-capacity memory, incurring great problems.

### DISCLOSURE OF THE INVENTION

The object of the current invention is to remove the inconvenience in the aforementioned previous examples and to present a method for compressing still image data and moving image data, permit transmission of high-quality image at low bit rates and allow storage of the data without using a large amount of memory.

To accomplish the aforementioned object, current invention discloses compressing still image data or moving image data, transmitting the data in a low number of frames or pixels, or in a low number of frames and pixels, the data in a low number of frames or pixels, or in a low number of frames and pixels, after it has been transmitted, and displaying the data after converting it into a high number of frames or pixels or into a high number of frames and pixels by time image interpolation or spatial image interpolation or by both time and spatial image interpolation.

The current invention also discloses compressing still image data or moving image data, storing the data in memory in a low number of frames or pixels, or in a low number of frames and pixels, retrieving the data in a low number of frames or pixels, or in a low number of frames and pixels, after storage, and displaying the data after converting it in a high number of frames or pixels, or in a high number of frames and pixels, by time or spatial image interpolation or by both time and spatial image interpolation.

According to the current invention, the compression system combines the existing compression technologies with new time and spatial image interpolation technologies, permitting an extremely high compression rate that has not been achieved by the existing technologies. It also permits: (1) Compression of the existing still image and moving image in effect by 8 and 12 times without reducing the original image quality; (2) Transmission of high-quality moving image (QCIF, 15 fps or more) at low bit rates of 32 Kbps or less; and (3) Increasing by 8 and 12 times the number of compressed images that can be stored using the same memory as that used by existing compression technologies while maintaining the same image quality as that of the existing technologies.

### BRIEF DESCRIPTION OF THE DRAWINGS

FIG. 1 is a diagram of the method for compressing still image data and moving image data according to the current invention.

FIG. 2 is a diagram of the image storage unit in the method for compressing still image data and moving image data according to the current invention.

FIG. 3 is an explanatory schematic drawing of an embodiment of the method for compressing still image data and moving image data according to the current invention.

FIG. 4 is a diagram of the first embodiment of the method for compressing still image data and moving image data according to the current invention.

FIG. 5 is a diagram of the second embodiment of the method for compressing still image data and moving image data according to the current invention.

FIG. 6 is a diagram of the third embodiment of the method for compressing still image data and moving image data according to the current invention.

FIG. 7 is a diagram of the fourth embodiment of the method for compressing still image data and moving image data according to the current invention.

FIG. 8 is a diagram of the fifth embodiment of the method for compressing still image data and moving image data according to the current invention.

FIG. 9 is a diagram of the sixth embodiment of the method for compressing still image data and moving image data according to the current invention.

### BEST MODE OF CARRYING OUT THE INVENTION

A detailed description of the method of the current invention will now be given with reference to the accompanying drawings.

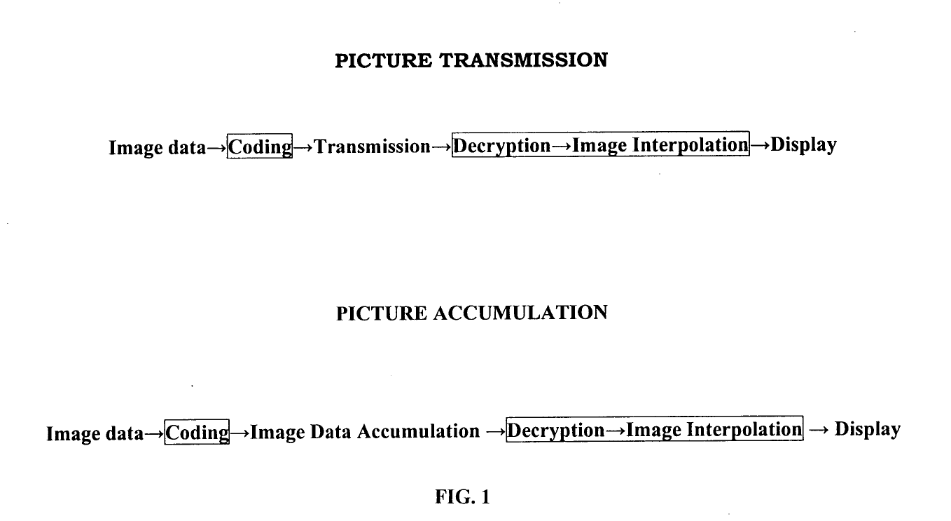

FIG. 1 is a diagram showing the compression and transmission method of still image data and moving image data according to the current invention. For example, in the transmission of an image, the image data is entered and encoded (encrypted) using one of the conventional technologies. Then, the data is transmitted, decoded, interpolated and displayed. It is important to note that the compression technology used in the current invention is not particularly restricted.

In the accumulation of an image, the image data is entered and encoded with the conventional compression technology. The data is stored in memory and then accumulated. The data is then decoded and displayed after the image is interpolated.

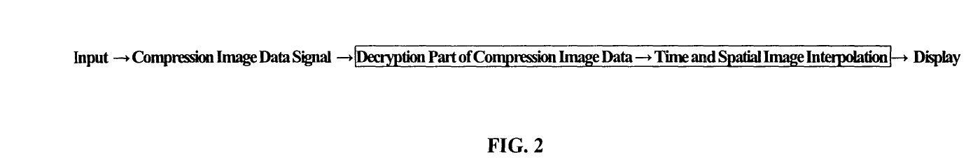

As shown in FIG. 2, the image interpolation unit consists of a decoding sub-unit of compressed image data, time or spatial interpolation sub-unit, or of a time and spatial interpolation sub-unit. The compressed image data signal of the input data is decoded and then submitted to time or spatial interpolation, or time and spatial interpolation.

The time interpolation and spatial interpolation can be achieved by employing currently known technologies. One example of time interpolation is given below.

In the transmission of images, currently existing compression technology permits transmission of only several to several tens of frames per second because of problems such as transmission speed of the line used. If only a small number of frames can be transmitted, moving images, in particular, may be transmitted with an unnatural behavior. For example, a flying ball may be recognized as stopping or moving unnaturally. To remove such irregularity, interpolation technology is commonly employed.

One of the more commonly employed techniques is compression encoding and decoding of image data. According to this technology, it is possible to increase the number of frames that can be transmitted per second. However, if the compression rate is increased by such compression encoding, the quality of image decoded may be deteriorated.

To permit smooth behavior of still or moving image, the time between frames, t, is set to one second (time to appearance of a succeeding frame), and one second is divided into two or more portions. For every unit of millisecond, an interpolated image is inserted. This is called time image interpolation.

The image is interpolated by using a change of brightness from one image to the succeeding image. Thus, smooth transition of images can be achieved by use of an optical illusion, nearing a real behavior.

If one looks at a preceding frame being t=0 and a current frame being t=1, and supposes that a ball shifts from left to right. In the course of the ball shift, the color of the picture element for the ball changes to the background color of the image. The color of the picture element for a new ball position changes from the background color to the color of the ball. In this case, for example, in the color compensation, the difference of brightness of the colors (optical R, G, B) between frames is divided by the linear interpolation method. That is, an interpolating image is made so that the brightness at t=0 will gradually change to the brightness at t=1. If images are inserted for every 200 milliseconds for the duration of one second from t=0 to t=1, four interpolating images are required. The interpolating images so made are inserted for every 200 milliseconds and continuously displayed for the duration of interpolation between t=⅕ to t=⅘.

To the human eyes on a monitor, the afterimage of the disappearing ball seems to shift by optical illusion, as the eyes are attracted by color of the appearing ball. Because of this, the ball, which does not exist, actually seems to exist and fly naturally.

An example of means to make interpolating images between frames is the use of linear interpolation.

In spatial image interpolation, an image may appear to have been enlarged or reduced, when it is displayed in a size other than the original one. In this regard, it is essential not to deteriorate the quality of image. When increasing the resolution of the image, or enlarging or reducing the image, it is necessary to make new pixels based on surrounding pixel information.

The spatial image interpolation method consists of enlarging the size of the image by inserting a new picture element between picture elements. Three well-known spatial image interpolation methods are: the nearest neighbor method, the bi-linear method, and the bi-cubic method. The nearest neighbor method consists of enlarging or reducing an original image. Because of marked jaggedness, this method is not adapted to re-sizing of markedly jagged images with graduation. The bi-linear and bi-cubic methods consist of mathematically calculating two or more images adjoining an original image and enlarging or reducing them. The bi-cubic method is adapted to re-sizing of more graded images that require precision and are complicated in calculation.

According to the current invention, an image is transmitted, or stored in memory, in a low number of frames or pixels, and is then displayed, after conversion, in a high number of frames or pixels, using combinations of image compression and decoding technology with interpolation technology.

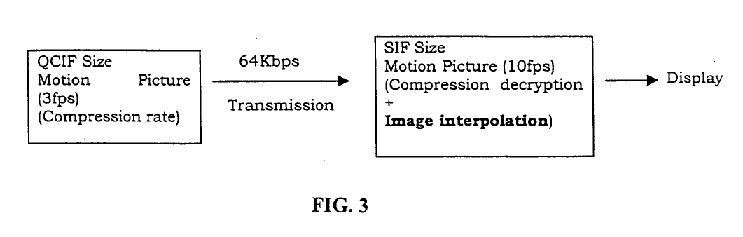

As shown in FIG. 3, camera image data input is compressed into QCIF size (encode: 3 fps) with a compression rate of 28.5, transmitted at 64 Kbps. The image is decoded under compression, and displayed in SIF size at 3 to 10 fps by time interpolation or spatial interpolation, or time and spatial interpolation.

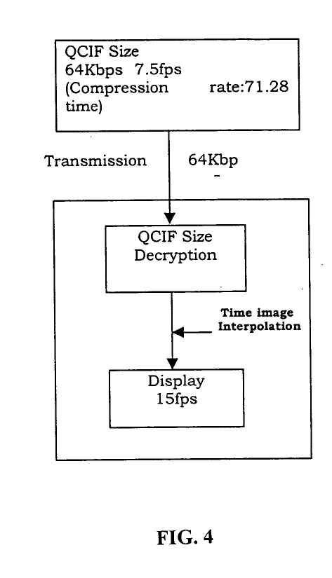

FIGS. 4, 5 and 6 are embodiments realized by interpolation. FIG. 4 shows an embodiment where an image of QCIF size (64 Kbps: 7.5 fps) is compressed (118.8 times), transmitted at 128 Kbps, uncompressed in SIF size, and then displayed at 15 fps by time interpolation.

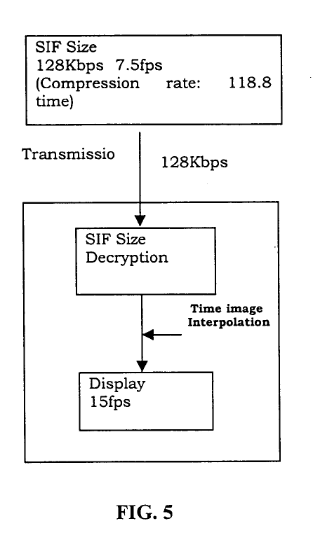

FIG. 5 is an embodiment where an image of SIF size (64 Kbps: 7.5 fps) is compressed (118.8 times), transmitted at 128 Kbps, uncompressed in SIF size, and then interpolated at 15 fps by time interpolation.

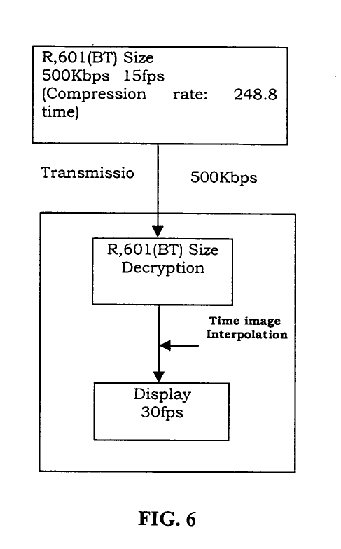

FIG. 6 is an embodiment where an image of R601 (BT) size (500 Kbps: 15 fps) is compressed (248.8 times), transmitted at 500 Kbps, uncompressed in R601 (BT) size, and then displayed at 30 fps by time interpolation.

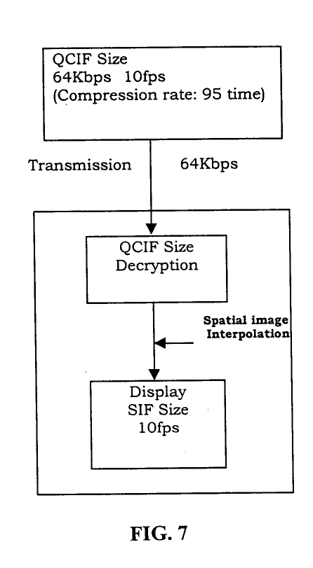

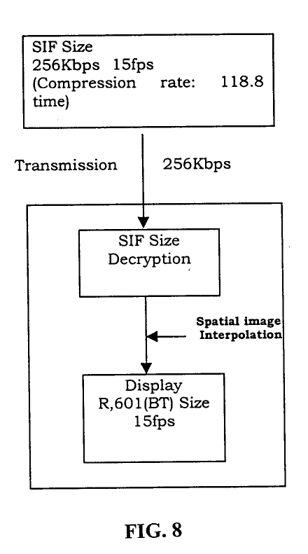

FIGS. 7 and 8 show embodiment using spatial interpolation. FIG. 7 shows an embodiment, where an image of QCIF size (64 Kbps: 7.5 fps) is compressed (95 times), transmitted in 64 Kbps, uncompressed in QCIF size, and then displayed in SIF size at 10 fps by spatial interpolation.

FIG. 8 indicates an embodiment, where an image of SIF size (256 Kbps: 15 fps) is compressed (118.8 times), transmitted in 256 Kbps, uncompressed in SIF size, and then displayed in R601 (BT) size at 15 fps by spatial interpolation.

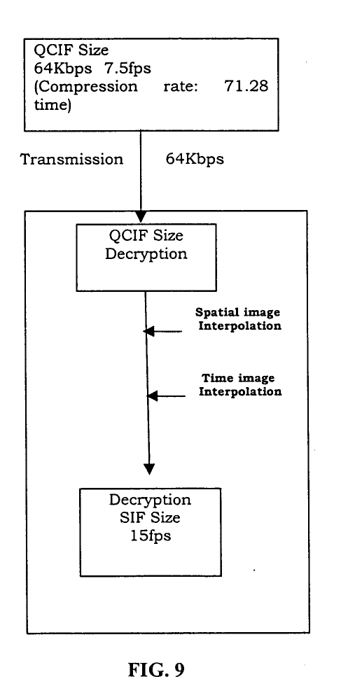

FIG. 9 shows an embodiment with time and spatial interpolation, where an image of QCIF size (64 Kbps: 7.5 fps) is compressed (71.28 times), transmitted at 64 Kbps, uncompressed in QCIF size, and then displayed in SIF size at 15 fps by time and spatial interpolation.

In another embodiment, not shown, camera image data input is compressed in QCIF size (encode: 5 fps), transmitted at 64 Kbps, and then displayed in SIF (or QVGA) size at 10 fsp by time and spatial interpolation.

In a further embodiment, camera image data input is compressed in SIF (or QVGA) size at 10 fps, transmitted at 128 Kbps, and then displayed at 30 fps in SIF (or QVGA) size.

In another embodiment, camera image data input is compressed in SIF (15 fps) is transmitted at 128 Kbps and then displayed in R.601 at 30 fps.

The current invention discloses a method for facilitating the compression transmission and/or low memory storage of high-quality images at low bit rates, decompressing those images, converting the images and displaying the images by using unique combinations of currently known technologies. The methods and procedures disclosed in the current application can be executed or preformed in a computer, other microprocessors, programmable electronic devices or other electronic circuitry that are used for encoding video film. They can be loaded into the above devices as software, hardware, or firmware. They can be implemented and programmed as discrete operations or as a part of a larger video compression and display strategy.

### Industrial Applicability

The aforementioned method for compressing still image data and moving image data according to the current invention allows an image to be effectively compressed such it is eight times smaller than images used in current strategies. When using the method disclosed herein, it is possible to send or receive image at low bit rates, which has not been realized by the existing compression technology, by combining the existing compression technology of still images and moving images with image interpolation technology. By application of this method, it will be possible to increase the image data storage capacity in storage media such as CD, DVD and hard disk by eight times.

In compliance with the statute, the invention has been described in language more or less specific as to the disclosed method. It is to be understood, however, that the invention is not limited to the specific steps shown or described, since the means and construction shown or described comprise preferred forms of putting the invention into effect. Additionally, while the current invention is described in terms of being used in compression of still image data and moving image data, it will be readily apparent to those skilled in the art that the invention can be adapted to other types of data as well. Therefore, the invention should not be construed as being solely limited to cooling systems for permanent magnet generators.

What is claimed is:

1. A method for compressing, transmitting, and displaying still image data and moving image data comprising the steps:
selecting data from the group comprised of still image data and moving image data;
compressing the data;
transmitting the data;
decompressing the data after transmission;
converting the data; and
displaying the data.

2. The method of claim 1 wherein the data is transmitted in a low number of frames and the data is converted into a high number of frames.

3. The method of claim 1 wherein the data is transmitted in a low number of pixels, the data is decompressed in a low number of pixels after transmission, and the data is converted into a high number of frames using spatial image interpolation.

4. The method of claim 1 wherein the data is transmitted in a low number of frames and a low number of pixels, the data is decompressed in a low number of frames and a low number of pixels after transmission, and the data is converted into a high number of pixels using time image interpolation and spatial image interpolation.

5. A method for compressing, storing, and displaying still image data and moving image data comprising the steps:
selecting data from the group comprised of still image data and moving image data;
compressing the data;
storing the data;
retrieving the data;
converting the data; and
displaying the data.

6. The method of claim 5 wherein the data is stored in a low number of frames, the data is retrieved in a low number of frames, and the data is converted into a high number of pixels using time image interpolation.

7. The method of claim 5 wherein the data is stored in a low number of pixels, the data is retrieved in a low number of pixels, and the data is converted into a high number of pixels using spatial image interpolation.

8. The method of claim 5 wherein the data is stored in a low number of frames and a low number of pixels, the data is retrieved in a low number of frames and a low number of pixels, and the data is converted into a high number of pixels using time image interpolation and spatial image interpolation.
